(19) United States
(12) Patent Application Publication
(10) Pub. No.: US 2006/0272605 A1
(43) Pub. Date: Dec. 7, 2006

(54) ELECTRIC COOLANT HEATER ASSEMBLY

(76) Inventors: Kenneth Wright, Lower Feltham (GB); James Ogden, London (GB); David Marlow, Sunbury-on-Thames (GB)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/143,304

(22) Filed: Jun. 2, 2005

(51) Int. Cl. F02N 17/02; F01P 1/06

(52) U.S. Cl. 123/142.5 E; 123/41.31

(57) ABSTRACT

An electric coolant heater assembly (10) has a coolant gallery (12) connected at each end to a fluid line of an engine's (E) coolant system (C). The gallery defines a fluid flow path through the assembly and includes baffles (24) for inducing turbulent flow to the fluid. A housing (20) mounted on one side of the gallery includes drive control electronics (18) for the assembly and a heater unit (14) is installed on the opposite side of the gallery. Heating elements (26) comprising the heater unit are energized by the drive control electronics. The drive control electronics are responsive to inputs from an external engine controller to operate an electric pump (P) and activate the heating elements so, at initial engine start-up, cause the coolant temperature to rise more rapidly than it otherwise would and assist the engine in reaching its nominal operating temperature faster than it otherwise would. Besides this initial engine warm-up assist, increased coolant temperature also adds to the amount of heat available to a heater (H) to heat the passenger compartment (PC) of the vehicle.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to an electric coolant heater assembly (ECP) installed in automotive vehicles or with stationary (static) engines, and more particularly, to such an assembly with an integral controller for use of the ECP with an electric pump and as a heat source for an engine coolant to accelerate engine warm up, and other engine (automotive or stationary) applications.

Electric coolant pumps are used in a vehicle's or static engine's cooling system to create a pressure differential that moves coolant through a coolant system. The system is designed to regulate the temperature of the coolant flowing through the engine so as to keep the engine operating within chosen temperature limits for a range of operating conditions. In an integrated cooling system, an electric coolant pump and an ECP, together with a fan, valve, and temperature sensor(s) are connected to an electronic controller for the vehicle or stationary engine to optimize the cooling system's performance for a given set of engine operating conditions. In particular, an important function of the cooling system is to maintain the temperature of metal parts below that at which damage will occur. For example, exhaust ports of an engine's combustion cylinder may be bridged by a thin metal section. If the temperature of the section becomes excessive, particularly on a repetitive basis, the resulting thermal stress will cause cracking and the engine's cylinder head will have to be replaced so the engine will function properly.

Further, the ECP assembly, in addition to the above, may be used to generate heat to compliment heating of the vehicle's passenger compartment or cell. Those skilled in the art will appreciate that an ECP assembly can perform one or more of these functions at the same time.

One approach to doing this has been to operate an ECP at its full speed, with coolant flow then being redirected back through the assembly and with only a small amount of coolant flowing to a core of the vehicle's heater. Heat is generated by losses in the system's hydraulics, the pump's motor, and the pump's controller. When heating is not required, but only coolant flow, the fluid is then directed to the cooling system and is not redirected back through the pump. The present invention is directed toward a construction which is more efficient in dissipating heat generated by operation of the pump, to reduce stress on the coolant assembly and extend its useful life.

### BRIEF SUMMARY OF THE INVENTION

The present invention is directed to an electric coolant assembly used in conjunction with an electric pump coolant which effectively and efficiently heats the engine's coolant so, at start-up, the engine reaches its operating temperature as soon as possible after the engine is started, as well as also supplementing the heat provided to the vehicle's passenger compartment by the vehicle's heater. The assembly includes a water gallery having fluid connections for connecting the unit in a fluid flow line of the cooling system. The gallery defines a fluid flow path through the assembly, including baffles for inducing a turbulent flow of fluid. The gallery also provides a substantial heating surface area in contact with the fluid so as to provide good heat distribution.

The assembly further includes a housing mounted on one side of the gallery and drive control electronics integral to the unit and installed in this housing. The drive control electronics are connected to an engine controller which supplies inputs to the electronics. The drive control electrics, in response to inputs from the engine controller, controls operation of the pump. A heater unit is mounted on the opposite side of the gallery and includes an arrangement of heating elements energized by the drive control electronics. Installing the heating unit remotely from the drive control electronics; i.e., on the opposite side of the gallery from the drive control electronics, facilitates easier dissipation of heat produced by the drive control electronics so to keep the electronics within a desired range of operating temperatures, in addition to reducing the time for the engine to warm-up and providing additional heat for the passenger compartment.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of an electric coolant heater assembly of the present invention;

FIG. 2A is an elevation view of the assembly, and FIG. 2B is a top plan view thereof;

FIG. 3 is an exploded view of the assembly;

FIGS. 4A and 4B are perspective views of opposite sides of a water gallery portion of the assembly;

FIG. 5 is a plan view of a heater plate of the assembly;

FIG. 6 is perspective view of a second embodiment of the assembly;

FIGS. 7A-7C illustrate respective vehicle system installations employing the assembly; and,

FIGS. 8A-8D illustrate representative assembly constructions for use in different vehicle or stationary engine configurations.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what is presently believed to be the best mode of carrying out the invention. As various changes could be made in the above constructions without departing from the scope of the invention, it is intended that all matter contained in the above description or shown in the accompanying drawings shall be interpreted as illustrative and not in a limiting sense.

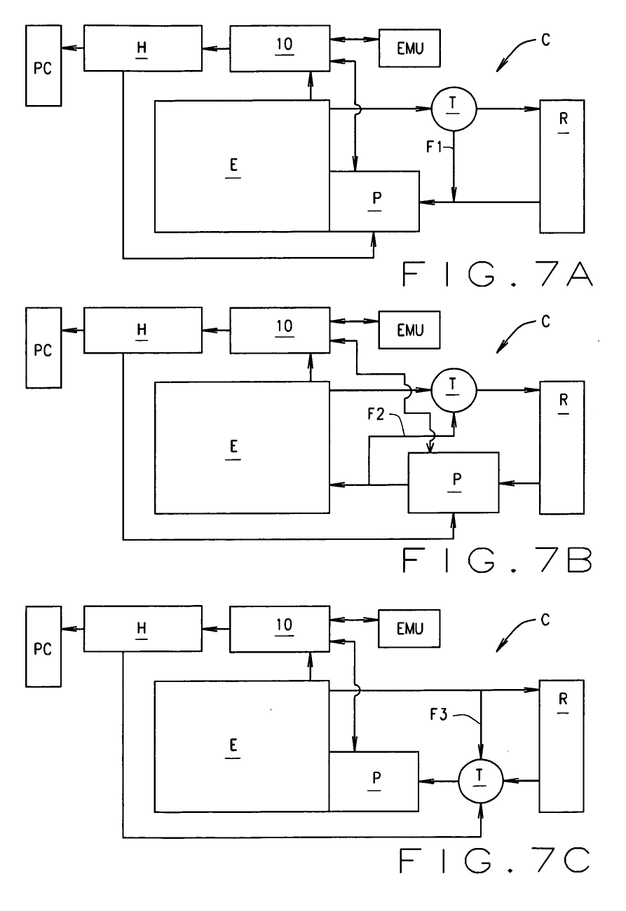

Referring to the drawings, an electric coolant pump assembly or ECP of the present invention is indicated generally 10. The assembly comprises part of a coolant system indicated generally C for a water-cooled internal combustion engine E. Three variations of the cooling system are shown in FIGS. 7A-7C; although those skilled in the art will understand that other system configurations are possible. In the cooling system, a water or coolant pump P pumps water into the engine where heat produced by the engine is transferred to, and heats, the water. An engine management unit or engine controller EMU supplies inputs to ECP 10. ECP 10, in turn, supplies inputs to pump P to operate the pump. Upon exiting the engine, some of the heated water flows to and through a radiator R where the heat is removed from the coolant and transferred to the atmosphere. The water then flows back to the engine through pump P. As shown in the drawings, a valve T is positioned in the fluid flow path between the engine outlet and the water pump inlet, either before or after the water passes through the radiator. In the embodiment of FIG. 7A, a bypass fluid flow path F1 extends between valve T and the inlet of pump P, bypassing radiator R. In FIG. 7B, a bypass fluid flow path F2 extends between the outlet of pump P and valve T, bypassing engine E; and in FIG. 7C, a fluid flow path F3 extends between the engine outlet and an inlet to valve T, again bypassing radiator R. The particular coolant system configuration is a function of the particular vehicle application and include mechanical pumps in addition to the pump P. In each instance, however, a portion of the coolant flowing through the engine is directed to an inlet of ECP 10. From the ECP, the coolant is directed through a core of a heater H to generate at least a portion of the heat available to the heater. From the heater, the coolant flows either directly back to pump P as shown in FIGS. 7A and 7B, or to the pump assembly through the valve T as shown in FIG. 7C.

Electric coolant assembly 10 is comprised of four main components. First is a coolant gallery indicated 12 through which a fluid (coolant) flows in the direction of the arrows. Located beneath the gallery is a heater plate indicated generally 14 which is installed in a housing 16. Mounted atop the gallery is a drive controller 18 installed in a housing 20 so to be integral to the assembly. For purposes of the present invention it is important to note that a) the heater plate and drive controller are mounted on opposite sides of gallery 12, and b) that the heater plate is installed adjacent to the gallery. By installing the heater plate and drive electronics on opposite sides of the gallery, the electronic components of the drive controller are not directly exposed to the heat produced when heating elements on heater plate 14 are energized. Also, housing 20 for the drive controller is mounted directly to the gallery. An important feature of the present invention is that with this assembly construction, heat produced in the electronics of drive controller 18 is transferred to the coolant flowing through the gallery, where it is useful during various stages of the engine operating cycle; e.g., during initial engine operations.

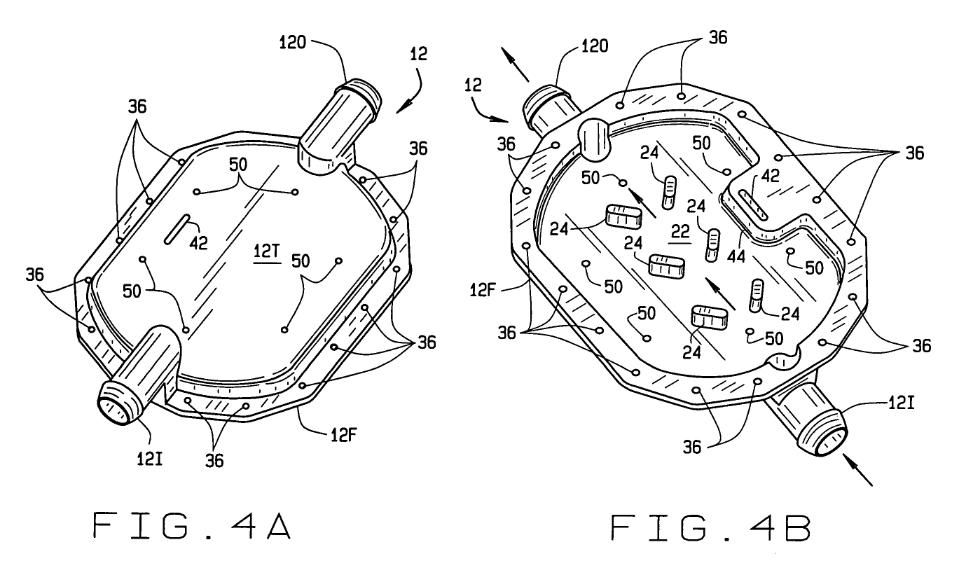

As shown in FIGS. 4A and 4B, gallery 12 is a die cast aluminum body having a recessed, central fluid flow section 22 as shown in FIG. 4B. A raised inlet 121 is formed at one end of the casting, and a raised outlet 120 is formed at the other end. The respective inlet and outlet are formed in a standard bayonet shape for fitting the ends of tubing (not shown) to the ECP. Water entering the ECP flows into the recessed central section of the gallery. Pairs of baffles 24 are arranged on opposite sides of the longitudinal centerline of the gallery. The baffles comprising each pair of baffles, three of which are shown in FIG. 4B, are equidistantly spaced from the centerline, and the baffles are arranged in a herringbone pattern. Coolant flowing into the gallery strikes the baffles which impart a turbulent flow to the fluid. This is important because it increases the amount of heat transfer imparted to the fluid, when heater plate 14 is energized, and the amount of heat transferred from the drive control electronics to the fluid. With respect to the design and construction of the gallery, those skilled in the art will understand that the flow path through the gallery and the placement of the baffles are exemplary only and that other gallery constructions are possible without departing from the scope of the invention. In FIGS. 8A-8D, for example, different flow paths are illustrated. FIG. 8A illustrates a straight line flow path similar to that shown in FIG. 4B with the inlet at one end of assembly 10 and the outlet at the other end. FIG. 8B illustrates a U-shaped flow path with the inlet and outlet at the same end of the assembly. FIG. 8C illustrates a L-shaped flow path with a 90° bend so that the inlet or outlet is at one end of the assembly and the other port is along one side of the assembly. FIG. 8D illustrates a serpentine flow path through the gallery. Similarly, it will be understood that given the particular flow path constructions, different baffle arrangements are used to impart turbulent flow through the gallery.

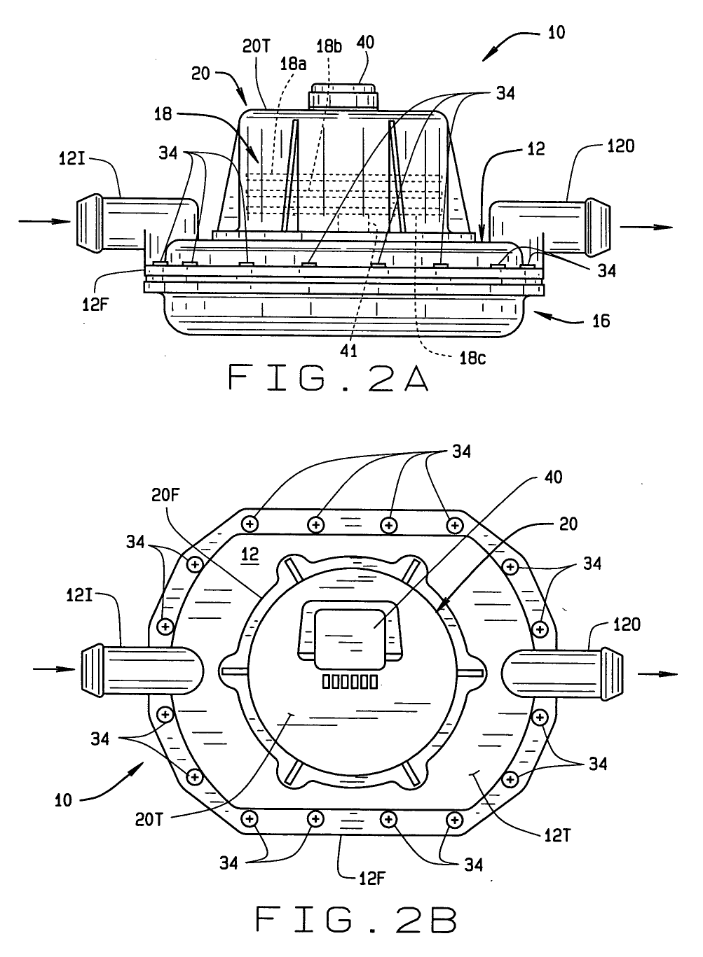

Heater plate 14 comprises, for example, a metal plate on which are printed eight 125W resistive heating elements 26 arranged in two parallel sets of four heaters each; although other heater arrangements could be employed. The metal plate provides good distribution of the heat produced by the heaters. Each pair of heaters has, for example, an associated M type thermal fuse 28 for safety purposes, and each pair of heaters is controlled by a MoSFET, IGBT, or other type of solid state relay 30. Switching inputs to the relays are provided by the drive control electronics 18 installed in housing 20. As shown in FIG. 2A, the drive control electronics comprise one or more printed circuit boards (PCBs) mounted within housing 20 on the opposite side of ECP assembly 10 from heater plate 14. In FIG. 2A, three PCBs 18-18c are shown installed in a vertical stack arrangement in housing 20. Those skilled in the art will understand that while, not shown, the PCBs could be installed in a horizontal arrangement.

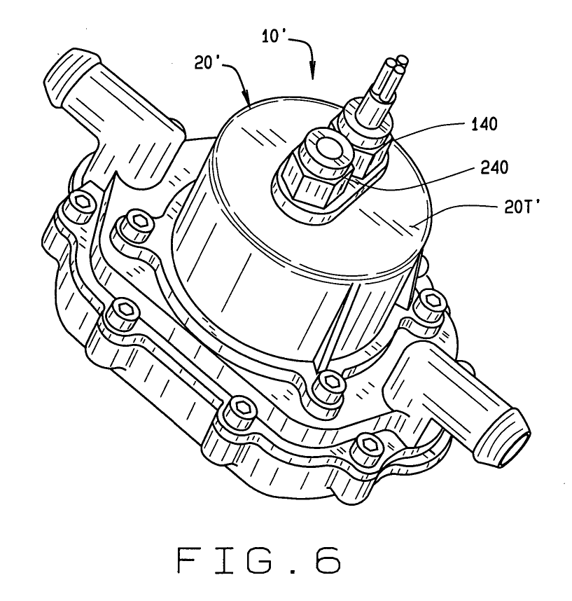

Plate 14 has a series of mounting holes 32 spaced about the periphery of the plate. Housing 16 has a shallow bowl shape with a series of correspondingly located vertical tabs 34 for seating plate 14 on a circumferential flange of the housing. Gallery 12 has an outer flange portion 12F in which are formed holes 36 corresponding to the holes 32 in plate 14. As shown in FIGS. 2A and 2B, when ECP 10 is assembled, the height of the tabs 34 are sufficient to extend through the height of flange 12F to secure plate 14 to the gallery. For convenience, no gaskets used in the assembly are shown in the drawings. Also, those skilled in the art will understand that other means of attaching gallery 12 and housing 16 together can be used; for example, nuts and bolts such as shown in FIG. 6. Plate 14 is installed on ECP 10 so heat produced by the heaters 26 directly heats the fluid flowing through the gallery so, for example, to shorten engine warm-up at start-up.

A temperature sensor 38, formed on plate 14, senses metal temperature and provides an input to drive control electronics 18 to assist operation of the heaters 26. In this regard, sensor 38 provides a metal temperature input to the controller. Operation of the heaters is signaled from a separate and remote engine controller (not shown) of the engine's management system and affected by drive control electronics 18 in response to a signal. Sensor 38 provides an input to the controller which monitors metal temperature, and in particular, determines if the temperature exceeds a preset limit. If the metal temperature does exceed this limit, the heaters will not operate. Hence, sensor 38 is similar to a thermal switch and guards against a low, or no, coolant condition, thereby to improve safety (by avoiding a very hot metal part under the bonnet) and limiting the possibility of heaters being damaged by trying to operate in an over-temperature condition.

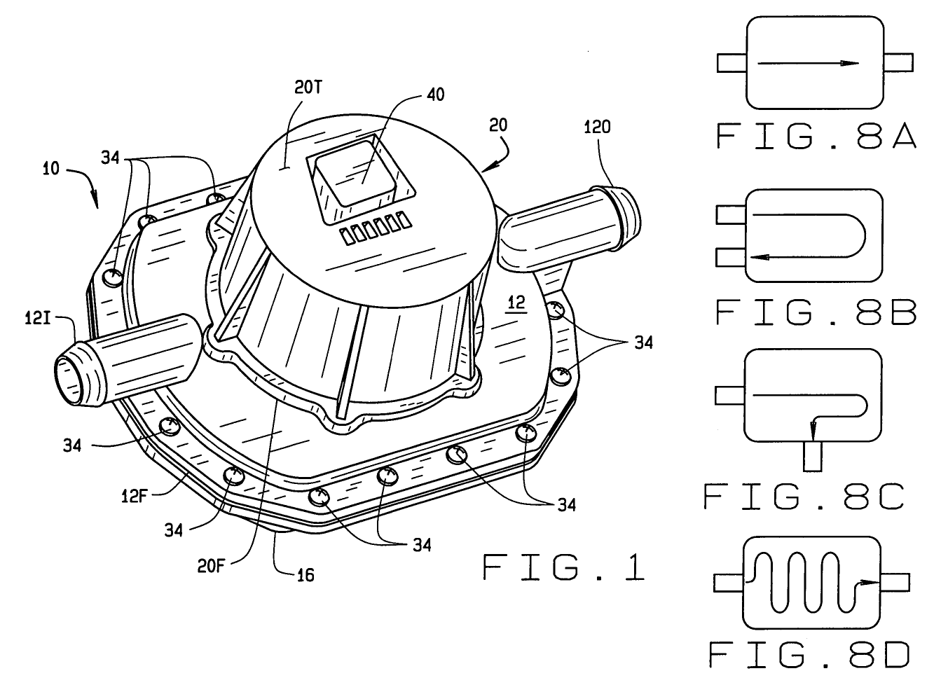

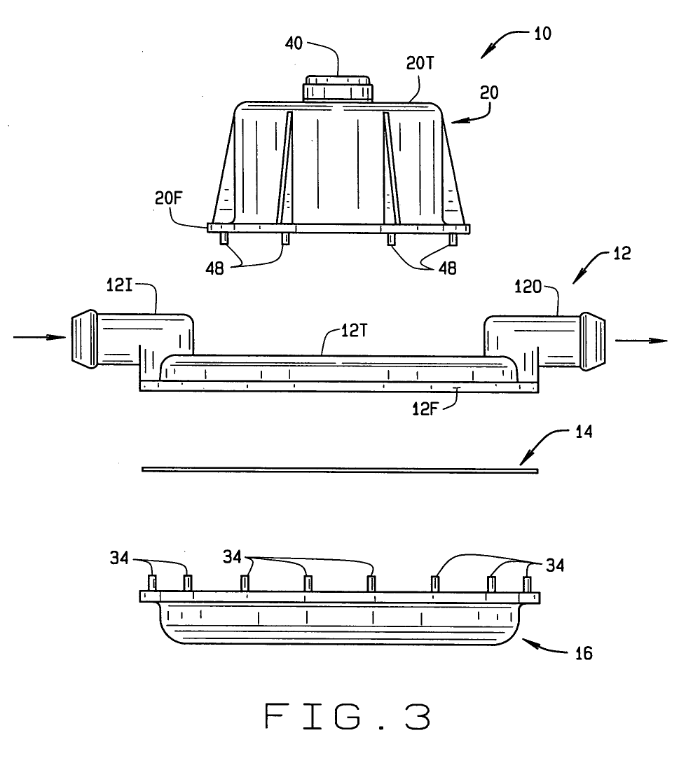

Drive control electronics housing 20 has an inverted cup shape and the PCBs 18a-18c on which drive control electronics 18 are mounted are installed within the housing as described above. The open end, base portion of the housing seats against a flat, upper surface 12T of gallery 12. An electrical connector 40 is formed in a top 20T of housing 20 for connecting drive control electronics 18 to engine management unit EMU. The engine management unit operates to control overall engine operations in response to a variety of inputs as is known in the art. In FIG. 6, an alternate connector configuration is shown for an ECP assembly 10′. In this assembly construction, a pair of connectors 140 and 240 are formed in the top 20T of a housing 20′. Referring to FIGS. 1-3, with respect to ECP assembly 10, a series of uniformly spaced, vertical tabs 48 extend downwardly from the bottom surface of flange 20F. Correspondingly spaced openings 50 extend into and through top 12T of gallery 12 to allow housing 20 to be attached to the upper portion of the gallery. Again, those skilled in the art will understand that other means of attaching housing 20 and gallery 12 together can be used.

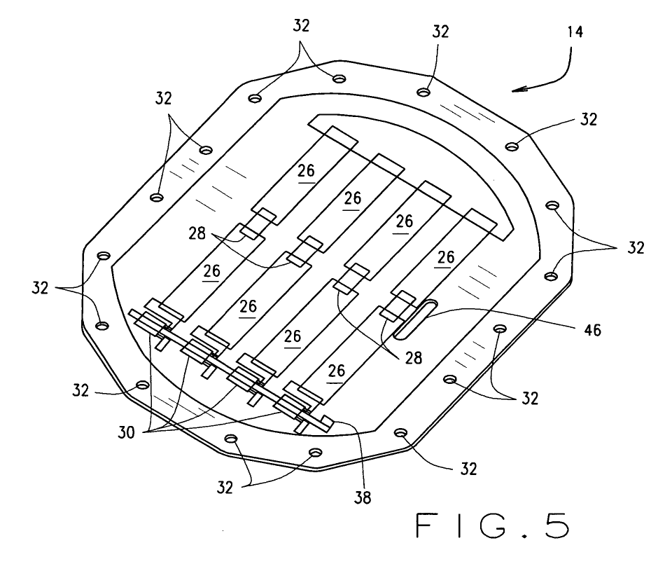

Referring to FIGS. 4A, 4B, and 5, an electrical cable 41 extends from the PCBs comprising drive control electronics 18 to heater plate 14 to provide control inputs to the MoSFETs or IGBTs 30, and sensor 38. A slot 42 extends through top 12T of the gallery and an inset 44 formed on the inner surface thereof. A correspondingly sized and placed slot 46 is formed on plate 14. Cable 41 extends through slot 42 to connect between the drive control electronics and heater plate.

In operation, when coolant is flowing through ECP assembly 10, the heaters 26 are switched “ON” by the drive control electronics 18 in housing 20 energizing the relays 30 which control the supply of electricity to the heaters. Commands from drive control electronics 18 to the heaters is in response to inputs from the engine management unit. The ECP is further responsive to these inputs to control operation of pump P; e.g., the speed of the pump. The heaters heat the fluid as it flows through the gallery. At the same time, heat produced by the drive control electronics is transferred through housing 20 into gallery 12 where it is drawn off by the coolant. Depending upon the particular engine operating conditions, energizing the heaters 26, at initial engine start-up, causes the coolant temperature to rise more rapidly than it otherwise would. This elevated coolant temperature will, in turn, assist the engine in reaching its nominal operating temperature faster than it otherwise would because of heat transfer from the coolant to the engine; so long as the coolant temperature exceeds the engine temperature. It will be understood that as the temperature differential (?T) between the coolant and metal decreases, there is less heat transfer between the two. Besides this initial engine warm-up assist, increased coolant temperature also adds to the amount of heat available to heater H to heat the passenger compartment of the vehicle.

Finally, those skilled on the art will understand that besides controlling electric pump P and the heaters 26, drive control electronics 18 can also be used to control other equipment. For example, drive control electronics 18 can be used to operate a Y-connected brushless D.C. motor such as a fan motor.

In view of the above, it will be seen that the several objects and advantages of the present invention have been achieved and other advantageous results have been obtained.

1. An electric coolant heater assembly for use in automotive vehicle having an engine whose operation is controlled by an engine controller comprising:
a gallery by which a fluid flows through the assembly from an inlet to an outlet thereof;
heating means installed on one side of the gallery for heating fluid flowing through the gallery; and,
control means installed on an opposite side of the gallery for controlling the heating means so the gallery is interposed between the heating means and control means, the control means being responsive to inputs from an the engine controller to activate the heating means so, at initial engine start-up, the fluid is heated by the heating means for its temperature to rapidly rise and assist the engine in reaching its nominal operating temperature faster than it otherwise would.

2. The assembly of claim 1 in which the control means is further responsive to the engine controller to activate the heating means to heat the fluid and increase the amount of heat available to heat a passenger compartment of a vehicle in which the assembly is installed.

3. The assembly of claim 2 in which heat produced by operation of the control means is drawn off by fluid flowing through the gallery so to maintain the operating temperature of the control means within a desired temperature range.

4. The assembly of claim 1 in which the gallery has a fluid flow path therethrough, the path being a straight line path extending from one end of the assembly to the other.

5. The assembly of claim 1 in which the gallery has a U-shaped fluid flow path therethrough.

6. The assembly of claim 1 in which the gallery has a L-shaped fluid flow path therethrough.

7. The assembly of claim 1 in which the gallery has a serpentine fluid flow path therethrough.

8. The assembly of claim 4 including at least one baffle interposed in the fluid flow path and creating turbulent flow of fluid flowing through the path.

9. The assembly of claim 8 including pairs of baffles arranged on opposite sides of a longitudinal centerline of the fluid flow path.

10. The assembly of claim 9 in which the baffles of each pair are equidistantly spaced from the centerline and form a herringbone pattern for fluid flowing through the gallery to strike the baffles and impart a turbulent flow to the fluid.

11. The assembly of claim 1 in which the heating means includes a heater plate on which is formed a plurality of heaters and means for energizing the heaters in response to a signal from the control means.

12. The assembly of claim 11 in which the means for energizing the heaters includes at least one solid state relay.

13. The assembly of claim 12 in which the heaters are arranged in pairs of heaters and a solid state relay controls energizing of each heater pair.

14. The assembly of claim 11 further including means for attaching the heater plate to the gallery.

15. The assembly of claim 1 in which the drive control means comprises at least one printed circuit board and the assembly further includes a housing in which the board is installed.

16. The assembly of claim 15 further including a cable extending from the control means through the gallery to the heating means for the control means to energize the heating means.

17. The assembly of claim 16 in which the gallery has an inset partially defining a fluid flow path through the gallery and the inset includes a slot through which the cable extends from one side of the gallery to the other.

18. (canceled)

19. The assembly of claim 15 in which the control means is responsive to an input from the engine controller to operate a separate, external device.

20. The assembly of claim 19 in which the external device is an electric coolant pump.

21. An electric coolant heater assembly includes a pump having a gallery through which coolant flows through the pump from an inlet to an outlet thereof, heating means for heating coolant flowing through the gallery, and a control means installed in the assembly and integral therewith for controlling the heating means, the control means being responsive to inputs from an external engine controller to activate the heating means so, at initial engine start-up, coolant is heated by the heating means for its temperature to rapidly rise and assist the engine in reaching its nominal operating temperature faster than it otherwise would.

22. The assembly of claim 21 in which the heating means is installed on one side of the gallery and the control means is installed on an opposite side thereof with the gallery interposed between the heating means and control means, whereby heat produced by the operation of the control means is readily drawn off by coolant flowing through the gallery so to maintain the operating temperature of the control means within a desired temperature range.

23. The assembly of claim 22 in which a vehicle has a passenger compartment, the assembly is installed in the vehicle, and the control means is further responsive to the engine controller to activate the heating means to heat the coolant and increase the amount of heat available to heat the passenger compartment.

24. The assembly of claim 21 in which the gallery defines a coolant flow path through the assembly and the assembly further includes baffles interposed in the flow path and creating turbulent flow of the coolant.

25. The assembly of claim 21 in which the heating means includes a heater plate on which is formed a plurality of heaters and means energizing the heaters in response to a signal from the control means.

26. The assembly of claim 25 in which the means energizing the heaters includes at least one solid state relay.

27. The assembly of claim 21 in which the drive control means comprises at least one printed circuit board and the assembly further includes a housing in which the board is installed.

28. The assembly of claim 27 further including a cable extending from the control means through the gallery to the heating means for the control means to energize the heating means.

29. The assembly of claim 28 in which the gallery has an inset partially defining a fluid flow path through the gallery and the inset includes a slot through which the cable extends from one side of the gallery to the other.

30. The assembly of claim 19 in which the assembly is further responsive to the external engine controller to also operate an electric coolant pump.
